(19) United States
(12) Patent Application Publication
(10) Pub. No.: US 2021/0189921 A1
(43) Pub. Date: Jun. 24, 2021

(54) DYNAMIC SKIP FIRE CONTROL WITH A SINGLE CONTROL VALVE FOR MULTIPLE CYLINDERS

(71) Applicant: Tula Technology, Inc., San Jose, CA (US)

(72) Inventor: Paul R. Van Heyningen, Webster, NY (US)

(21) Appl. No.: 17/119,313

(22) Filed: Dec. 11, 2020

Related U.S. Application Data
(60) Provisional application No. 62/951,428, filed on Dec. 20, 2019.

(51) Int. Cl. F01L 13/00; F02B 75/20; F01L 1/24; F01L 1/18; F01L 1/047; F01L 1/46; F02D 41/00

(52) U.S. Cl. CPC F01L 13/0005; F02B 75/20; F01L 1/24; F02B 2075/1816; F01L 1/047; F01L 1/46; F02D 41/0087; F01L 1/18

(57) ABSTRACT

A control valve for a valve train in an internal combustion engine using four-way control logic for dynamic skip fire control of a pair of cylinders is described. A four cylinder engine can be controlled using two control valves, with each control valve controlling a pair of cylinders. Each control valve has four ports: one control port for each cylinder, a pressure inlet port, and a tank port. The control valve is used to activate or deactivate a cylinder's intake and/or exhaust valves.

### PRIORITY INFORMATION

This application claims priority of U.S. Provisional Application Ser. No. 62/951,428, filed on Dec. 20, 2019, the contents of which are incorporated herein by reference.

### FIELD OF DESCRIBED EMBODIMENTS

The described embodiments relate generally to internal combustion engines and to methods and arrangements for controlling internal combustion engines to operate more efficiently. More particularly, a valve train configuration with oil control valves for controlling dynamic skip fire cylinder deactivation using a single control valve for multiple cylinders is described.

### BACKGROUND

The output of many internal combustion engines is controlled by adjusting the mass air charge (MAC) delivered to each fired cylinder. An engine control unit (ECU) directs delivery of the appropriate fuel charge for the commanded MAC. Gasoline fueled engines generally operate with an air/fuel ratio at or near stoichiometry to facilitate conversion of harmful pollutants to more benign compounds in a catalytic converter. Control of the MAC is most easily accomplished by adjusting the throttle position, which in turn alters the intake manifold pressure (MAP). However, it should be appreciated that the MAC can be varied using other techniques as well. For example, variable intake valve lift control can be used to adjust the MAC. Adjusting the valve lift has the advantage of reducing pumping losses thereby increasing fuel efficiency, particularly at low or intermediate engine loads.

Over the years there have been a wide variety of efforts made to improve the fuel efficiency of internal combustion engines. One approach that has gained popularity is to vary the displacement of the engine. Most commercially available variable displacement engines effectively “shut down” or “deactivate” some of the cylinders during certain low-load operating conditions. When a cylinder is “deactivated”, its piston typically still reciprocates; however, neither air nor fuel is delivered to the cylinder so the piston does not deliver any net power. Since the cylinders that are shut down do not deliver any power, the proportional load on the remaining cylinders is increased, thereby allowing the remaining cylinders to operate with improved fuel efficiency. Also, the reduction in pumping losses improves overall engine efficiency resulting in further improved fuel efficiency.

Another method of controlling internal combustion engines is skip fire control where selected combustion events are skipped during operation of an internal combustion engine so that other working cycles operate at better efficiency. In general, skip fire engine control contemplates selectively skipping the firing of certain cylinders during selected firing opportunities. Thus, for example, a particular cylinder may be fired during one firing opportunity and then may be skipped during the next firing opportunity and then selectively skipped or fired during the next. From an overall engine perspective, skip fire control sometimes results in successive engine cycles having a different pattern of skipped and fired cylinders. This is contrasted with conventional variable displacement engine operation in which a fixed set of the cylinders are deactivated during certain low-load operating conditions. With skip fire control, cylinders are also preferably deactivated during skipped working cycles in the sense that air is not pumped through the cylinder and no fuel is delivered and/or combusted during skipped working cycles when such valve deactivation mechanism is available. The Applicant has filed a number of patent applications generally directed at dynamic skip fire control. These include U.S. Pat. Nos. 7,849,835; 7,886,715; 7,954,474; 8,099,224; 8,131,445; 8,131,447; 8,336,521; 8,449,743; 8,511,281; 8,616,181; 8,869,773; 9,086,020; 9,528,446; 9,689,327 and 9,399,964.

The hardware needed to implement valve lift control and deactivation tends to be relatively complex and expensive. Internal combustion engines typically use cam actuated intake and exhaust valves, so cylinder deactivation requires a mechanical system to allow or inhibit valve motion. Cylinder deactivation may be controlled by application of pressurized oil to a valve train element, which results in inhibition of valve motion. Oil flow may be controlled by an electrically activated oil control valve (OCV) that either directs oil flow to the deactivating valve train element or vents oil from the deactivating valve element depending on the position of a spool within a housing of the OCV. For conventional variable displacement engines having a fixed group of deactivatable cylinders, a single OCV may be used to control the activation state of all cylinders in the group. For a skip fire controlled engine, each deactivatable cylinder typically requires a dedicated OCV. In skip fire controlled engines having the capability to activate and deactivate each cylinder in the engine, the number of oil control valves will equal the number of engine cylinders. A cylinder may be deactivated by inhibiting motion of either all of the cylinder's intake valves, all of the cylinder's exhaust valves, or all of a cylinder's intake and exhaust valves. In the latter case, gas is trapped within the enclosed cylinder volume during deactivated working cycles.

The use of a singular deactivation control valve for each cylinder necessitates the creation of cylinder head OCV bores and supply/control passages for each OCV, resulting in additional mechanical complexity in an already constrained physical space. Also, each OCV requires electrical wiring. It would be desirable to reduce cylinder head and wiring complexity by reducing the number of oil control valves.

### BRIEF DESCRIPTION OF THE DRAWINGS

The embodiments will be readily understood by the following detailed description in conjunction with the accompanying drawings, wherein like reference numerals designate like structural elements, and in which:

FIG. 1 shows an embodiment of a conventional valve train configuration in which deactivation and reactivation of each cylinder is controlled using one control valve per cylinder.

FIG. 2 is a schematic diagram showing a cylinder control strategy of the embodiment shown in FIG. 1.

FIG. 3A is a table showing crankshaft rotation for a four cylinder engine with a typical 1-3-4-2 firing order.

FIG. 3B is a timing diagram showing valve lift profiles for a four cylinder engine with a typical 1-3-4-2 firing order.

FIG. 4 is a schematic diagram showing a cylinder control strategy for an embodiment of a valve train configuration having a deactivation control valve with four-way control logic.

FIGS. 5A-5D schematically illustrate the four spool positions of an oil-control valve with four-way control logic.

FIG. 6 is a cross-sectional view of an exemplary four-way control logic spool valve.

FIG. 7 shows the full matrix of control states for the two control valves of the embodiment shown in FIG. 4.

### DESCRIBED EMBODIMENTS

In this patent application, numerous specific details are set forth to provide a thorough understanding of the concepts underlying the described embodiments. It will be apparent, however, to one skilled in the art that the described embodiments may be practiced without some or all of these specific details. In other instances, well known process steps have not been described in detail in order to avoid unnecessarily obscuring the underlying concepts.

As discussed above, skip fire controlled engines deactivate cylinders when they are not needed to increase fuel efficiency. Such cylinder deactivation reduces engine pumping losses and generally results in more efficient combustion in fired working cycles. Cylinder deactivation may also be used to control temperature of the engine's exhaust gas to maintain a desired temperature in an aftertreatment system that reduces noxious emissions.

The present invention relates generally to methods and devices for controlling the operation of intake and exhaust valves of an internal combustion engine during skip fire operation. In various embodiments, the valves are controlled using an eccentric cam lobe to open and close the valves. A valve deactivation mechanism is incorporated in the valve train to allow deactivation of the valves during a skipped firing cycle. The valve deactivation mechanism may be incorporated in a valve train element such as a rocker arm, hydraulic lash adjuster, a lifter, a zero lift cam, or some other valve train element. The valve deactivation mechanism is controlled using a solenoid operated oil control valve. The solenoid operated valve allows introduction of a hydraulic fluid (such as motor oil) into the deactivation mechanism to either allow the deactivation mechanism to transmit the cam lobe profile into valve motion or mechanically decouple the valve from the cam lobe, leaving the valve in a closed position. An oil galley including a plurality of oil passageways may be used to deliver the pressurized oil from the solenoid operated valve to the deactivation mechanism. In many cases the hydraulic fluid shifts the position of a locking pin in the deactivation mechanism to shift the deactivation mechanism between its transmitting and decoupled state. Pressurized oil applied to the deactivation mechanism allows deactivation of the valve. That is the valve will remain closed as long as pressurized fluid is applied to the deactivation mechanism. In order to shift the locking pin position, the valve must be in its closed state. Once the valve has started to move from its closed position, i.e. a cam follower is starting to move off the base circle of the cam, the valve spring is applying enough force to the locking pin so that it cannot move out of place even if full oil pressure is applied.

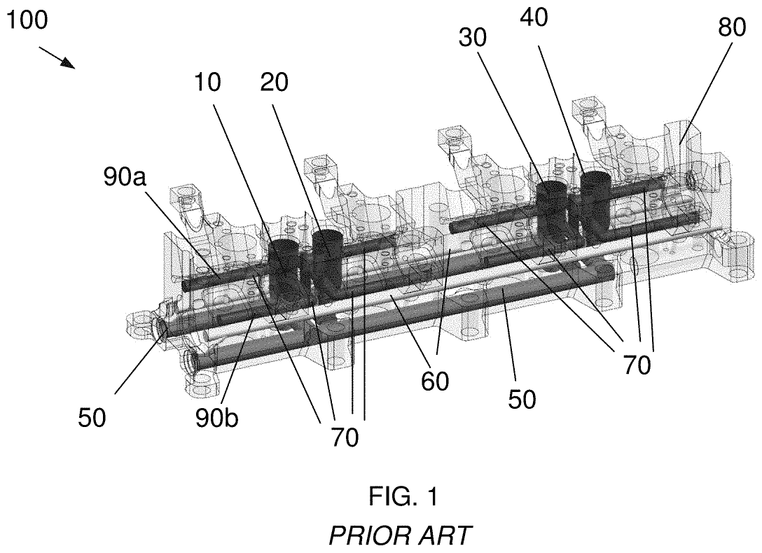

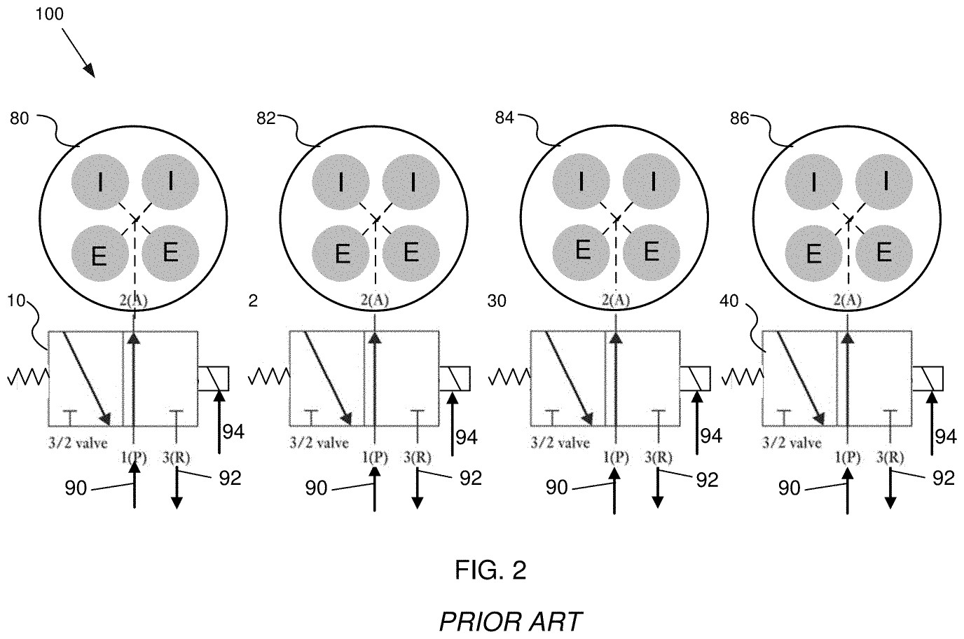

FIG. 1 shows such an exemplary prior art valve train configuration 100 for a four-cylinder, skip fire controlled engine. In FIG. 1 each cylinder's intake and/or exhaust valves are controlled by its own OCV 10, 20, 30, 40. Depending on the OCV position its associated cylinder is either activate (fired) or deactivated (skipped). In some cases, each cylinder may have two intake and two exhaust valves all of which can be activated and deactivated by the cylinder's associated OCV. The use of a singular deactivation control valve 10, 20, 30, 40 for each cylinder necessitates the creation of cylinder head OCV bores and supply/control passages for each OCV 10, 20, 30, 40 in the cylinder head 80. FIG. 1 shows the hydraulic complexity required for the different control circuits. As shown in FIG. 1, oil supply lines 50 (in red) feed each of the OCV 10, 20, 30 and 40 from the underside of the cylinder head 80. Depending on the position of the OCV, pressurized oil is fed into control passages 90a and 90b (in blue). In this example, both intake and exhaust valves are closed in deactivated working cycles and control passages 90a and 90b control the intake and exhaust valves, respectively. The control passages terminate in the deactivatable/reactivatable elements of each cylinders 80, 82, 84, 86 (FIG. 2) associated with each of the control valves 10, 20, 30 40. While the oil control valves are shown in FIG. 1 as being in the cylinder head they can be situated in other locations, such as a valve cover. Two separate oil galleries 60 (in yellow) feed oil to other elements located in the cylinder head to provide lubrication and serve other functions.

FIG. 2 is a schematic diagram showing a cylinder control strategy for the prior art valve train configuration shown in FIG. 1. In this valve train, each cylinder 80, 82, 84, 86 has two intake and two exhaust valves, denoted with an I for intake or E for exhaust over the cylinder. Depending on the nature of the cylinder deactivation, either the two intake valves may be deactivated, the two exhaust valves may be deactivated, or all the valves may be deactivated. In FIG. 2 the dashed line going to each valve indicate that in this engine all cylinder valves are deactivated when a cylinder is deactivated. In FIG. 2, adjacent each cylinder 80, 82, 84, 86, a schematic fluid control diagram of an oil control valve is shown for each of the cylinders 80, 82, 84, 86. The fluid control schematic valve diagram shows that each oil control valve 10, 20, 30, and 40 is a three-way, two-position control valve for each cylinder 80, 82, 84, and 86, respectively. Each control valve 10, 20, 30, 40 is supplied with a pressurized oil line 90, a return oil line 92, and an electrical control circuit 94 to shift the valve position. As shown in FIG. 2, each of the oil control valves 10, 20, 30, 40 has three ports, which are numbered 1, 2, 3. Each OCV may be in one of two positions: a first position with port 1 connected to port 2 and a second position with port 2 connected to port 3. In the first position, pressurized oil from pressurized oil line 90 is directed to a cylinder's deactivation mechanism. In the second position, pressurized oil may drain from the cylinder's deactivation mechanism into the return line 92. In the illustrated embodiment shown in FIG. 2, each of the control valves 10, 20, 30, 40 is a solenoid electromagnetic control valve with a return spring. However, it will be appreciated that other types of control valves may be used.

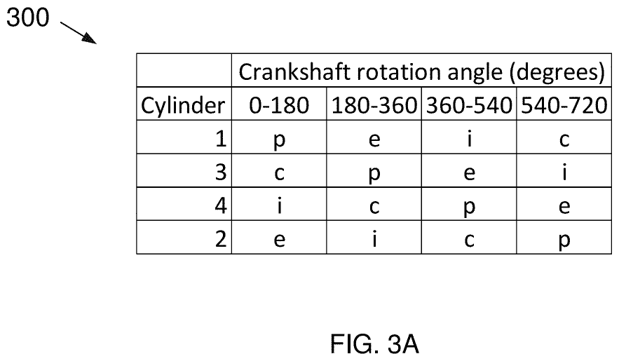

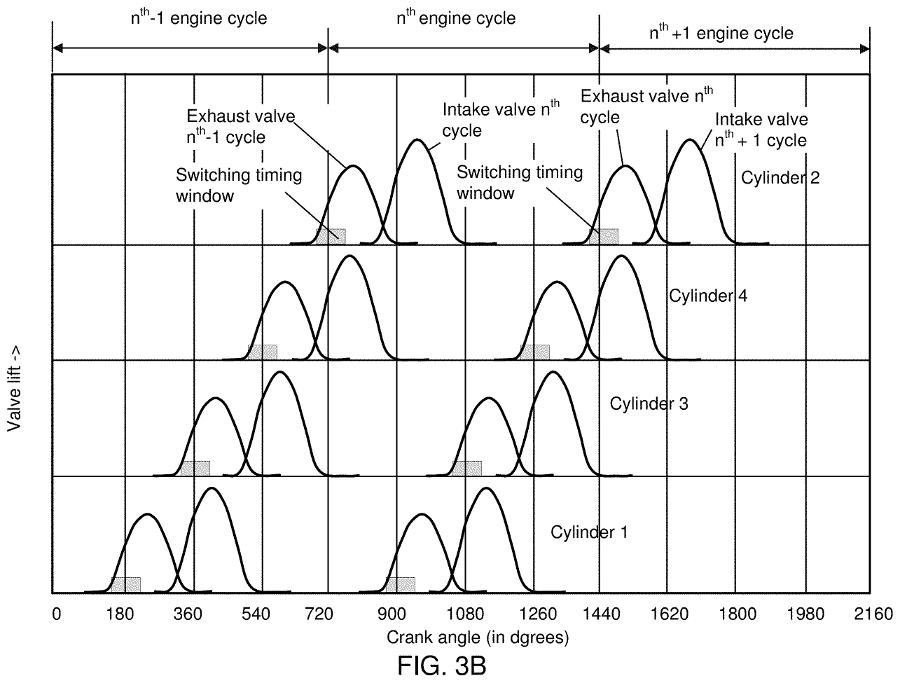

The typical firing order for a four-cylinder engine is: 1-3-4-2. That is, cylinder #1 fires first, followed by cylinder #3, then cylinder #4, and finally cylinder #2. FIG. 3A is a table 300 showing crankshaft rotation angle for a typical four-cylinder engine with a typical 1-3-4-2 firing order. For a four-stroke engine, there are the following strokes: intake “i”, compression “c”, power “p”, and exhaust “e”. The table shows that for every 180 degrees of crankshaft rotation there is a power stroke. Also, the table in FIG. 3 shows each cylinder's stroke relative to that of the other cylinders.

Thus, as shown in FIG. 3A, the crankshaft rotates 180 degrees and Cylinder #1 starts by firing, with its power stroke “p”. Then the crankshaft rotates another 180 degrees and Cylinder #1 moves to its exhaust stroke “e”. The crankshaft then rotates another 180 degrees and Cylinder #1 executes its intake stroke “I”, and when the crankshaft rotates another 180 degrees, Cylinder #1 completes its compression stroke “c”. It then cycles back to the beginning with Cylinder #1 again executing a power stroke. Working cycles of each of the engine's cylinders are offset from Cylinder #1 by 180 degrees (or multiples of 180).

In dynamic skip fire control, a deactivation or reactivation command for a working cycle may be given during an exhaust stroke of the previous cycle. During the exhaust stroke, the intake valve is at rest when a activate/deactivate command is ushered in, and depending on the command, the intake valve is either activated (lifted) or deactivated (no lift) in the subsequent working cycle. In this control architecture the intake valve(s) of the deactivated working cycle are deactivated before the exhaust valve(s) of the deactivated working cycle. It should be understood that the timing of the activation and deactivation of the valves is not limited to this configuration. Applicant's pending U.S. patent application Ser. No. 15/982,406 describes various intake and exhaust valve timing strategies that may be used in cylinder deactivation and is incorporated herein by reference in its entirety for all purposes.

FIG. 3B shows exemplary valve lift profiles associated with the table 300 depicted in FIG. 3A. The intake valve lift is shown as lower than the exhaust valve, since this is generally the case. As evident by inspection of FIG. 3B, for each cylinder there may be overlap between the closing of exhaust valve on the n^{th}−1 engine cycle and the opening of the intake valve on the n^{th} engine cycle; however, once a stroke is initiated the deactivation mechanism can be switched without impacting the initiated stroke. Thus, after the exhaust valve begins to lift, the deactivation mechanism can be switched to a new state (if desired) without impacting the exhaust valve motion on the initiated stroke. This means that there is a switching timing window after the exhaust valve has lifted when the intake valve may be switched to a deactivated position. The switching must be accomplished prior to the time that intake valve lift would occur, i.e. before a cam follower moves off a base circle. The exact location and duration of the switching time window is a function of engine speed and cam phaser adjustment (in engines equipped with cam phasers).

An important observation from FIG. 3B is that the switching time windows for each cylinder do not overlap. Thus, for any pair of cylinders one cylinder in the pair may be switched without impacting the state of the other cylinder in the pair. In a four cylinder engine the cylinders may be paired in three possible ways, cylinder 1 may be paired with cylinder 2, cylinder 1 may be paired with cylinder 3, or cylinder 1 may be paired with cylinder 4. The remaining cylinders may then be paired with each other, i.e. cylinder 3 paired with cylinder 4, cylinder 2 paired with cylinder 4, or cylinder 2 paired with cylinder 3, respectively. In some of these pairings, paired cylinders have consecutive firing opportunities, i.e. cylinder 1 paired with cylinder 2 and cylinder 3 paired with cylinder 4 or cylinder 1 paired with cylinder 3 and cylinder 2 paired with cylinder 4. In other pairings, the paired cylinders have firing opportunities that are not consecutive but have an intervening firing opportunity from the other cylinder pair, i.e. cylinder 1 paired with cylinder 4 and cylinder 3 paired with cylinder 2. Any of the above cylinder pairings may be used. In some embodiments, physically adjacent cylinders may be paired together, since this may minimize the length of a hydraulic control line between the oil control valve and its controlled cylinders. In other cases, it may be desirable to pair non-adjacent cylinders so that the timing of the control signals to the paired cylinders are well spaced, which may allow skip fire operation a higher engine speeds.

Embodiments of valve train configurations described herein include an internal combustion engine that implements dynamic skip fire by introducing four-way control logic for two cylinders, thereby reducing the number of control valve components required and reducing the complexity of cylinder head machining. The cylinders may be adjacent each other so as to minimize the distance between a 4-way oil control valve and the cylinders which it controls. According to embodiments described herein, only two oil control valves are required for a four cylinder engine, as each control valve can control two cylinders.

According to embodiments described herein, the use of four-way control logic within a deactivation oil control valve allows for each oil control valve to provide dynamic skip fire control for pairs of cylinders. This reduces the number of required oil control valves and simplifies cylinder head machining. According to an embodiment described in more detail below, each four-way oil control valve can modulate among four positions to control pairs of cylinders. For example, a control valve can modulate among: Position #1: Fire both cylinder 1 and 2, Position #2: Skip cylinder 1 and Fire cylinder 2, Position #3: Skip both cylinder 1 and 2, and Position #4: Fire cylinder 1 and Skip cylinder 2. Thus, a single 4-way oil control valve can generate any given firing pattern for the two cylinders it controls as dictated by the system operating control logic.

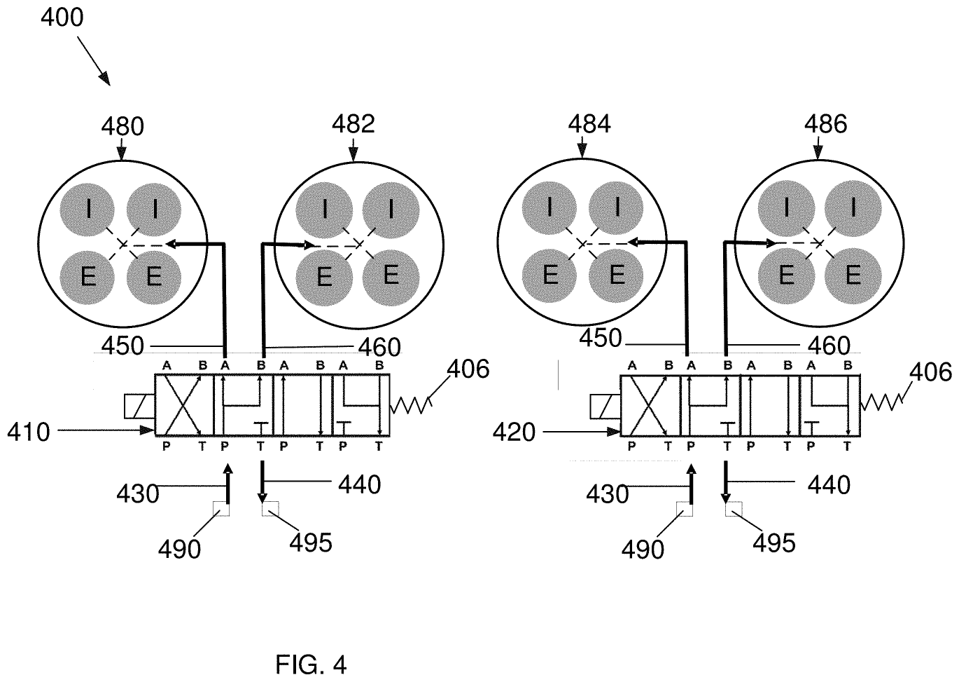

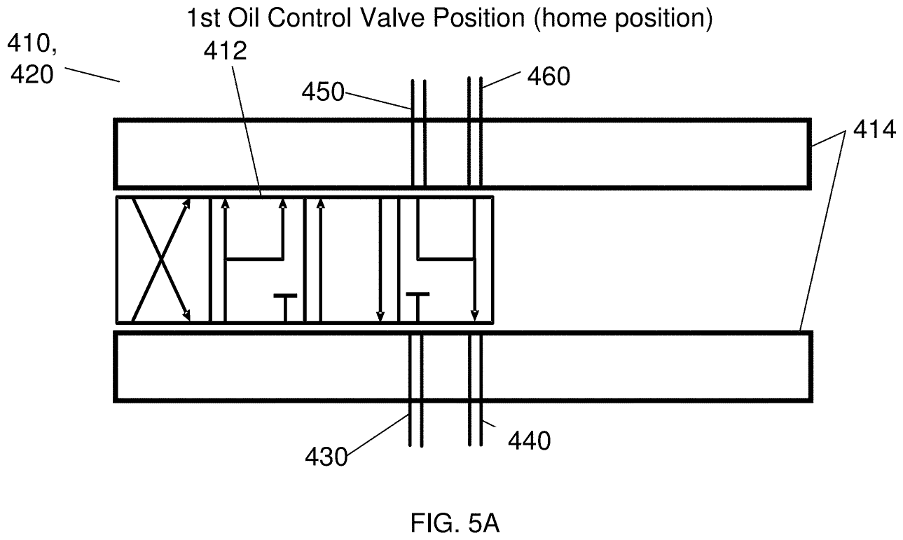

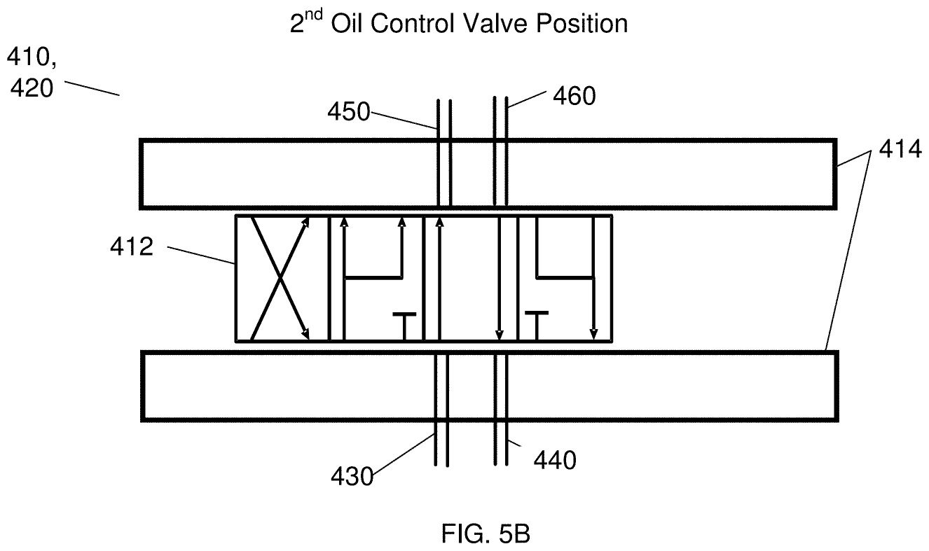

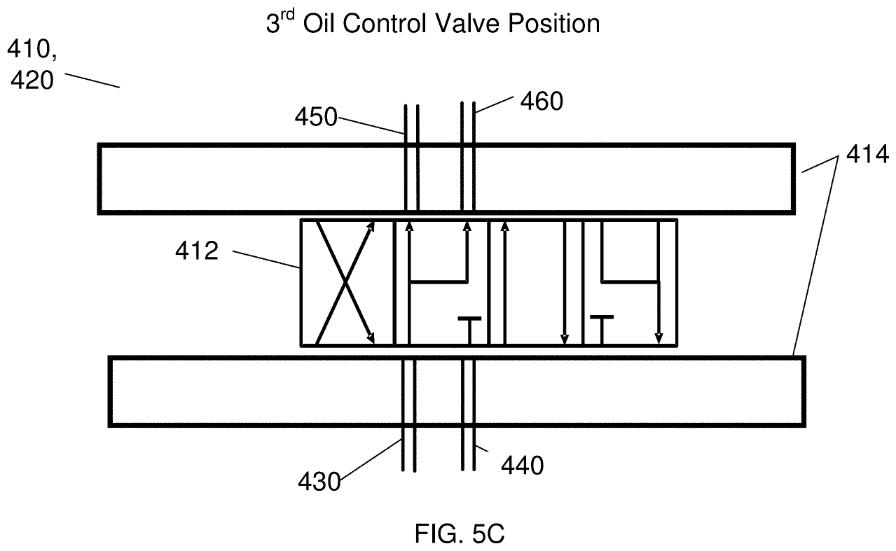

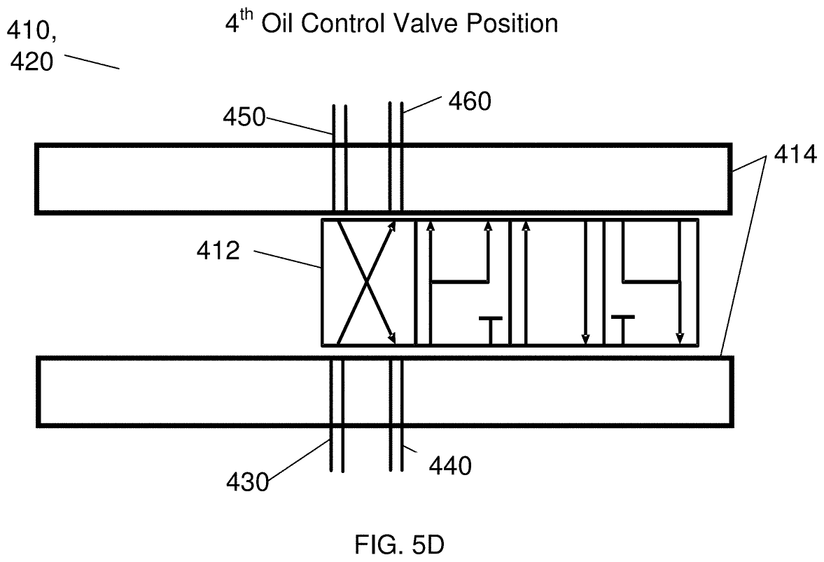

With reference to FIGS. 4-5, an embodiment of a valve train configuration 400 having an oil control valve with four-way control logic is described with respect to a four-cylinder engine. The oil control valve with four-way control logic is designed to control a pair of cylinders, which may be adjacent to each other. It will be noted that reducing the number of oil control valves from four to two in a four-cylinder engine does not affect the available firing patterns. Similarly, reducing the number of oil control valves from eight to four in an eight-cylinder engine does not affect the available firing patterns. Using a four-way control logic valve to control two cylinders allows any desired firing pattern to be achieved in engines having an even number of cylinders.

FIG. 4 is a schematic diagram showing a cylinder control strategy for such a valve train configuration 400. According to this embodiment, the valve train configuration 400 is for a four-cylinder engine and only two control valves 410, 420 are necessary for controlling deactivation and reactivation of the engine's four cylinders. As shown in FIG. 1 and as described above, a prior art valve train for a four-cylinder engine with individual cylinder deactivation capability has four oil control valves, one oil control valve for each cylinder. As shown in the embodiment of FIG. 4, the first oil control valve 410 controls deactivation and reactivation of two adjacent cylinders (Cylinder #1 480 and Cylinder #2 482) and the second oil control valve 420 controls deactivation and reactivation of the other two adjacent cylinders (Cylinder #3 484 and Cylinder #4 486). It will be understood that, although described with reference to a four-cylinder engine, the control valve embodiments described herein can also be applied to an eight-cylinder engine (with double the number of control valves) as well as an inline six-cylinder engine (with three control valves).

In FIG. 4, each of the oil control valves 410, 420 is schematically represented by a fluid control valve diagram. Each of the control valves 410, 420 has four ports: an inlet pressure port 430, a tank port 440 for the return for venting to a tank 495, a control port A 450, and a control port B 460. As shown in FIG. 4, the inlet pressure port 430 receives oil from an oil supply 490 to supply control port A 450 and control port B 460 with hydraulic pressure. In the first control valve 410, control port A 450 is for deactivating and reactivating elements in Cylinder #1 480 and control port B 460 is for deactivating and reactivating elements in adjacent Cylinder #2 482. Similarly, in the second control valve 420, control port A 450 is for deactivating and reactivating elements in Cylinder #3 484 and control port B 460 is for deactivating and reactivating elements in adjacent Cylinder #4 486. Each of the oil control valves 410 and 420 has a return spring 406 that forces the valve into a home position if no electrical energy is applied to the oil control valve.

As previously described a cylinder may be deactivated by leaving its intake valve(s) closed during a working cycle, leaving its exhaust valve(s) closed during a working cycle, or leaving both its intake valve(s) and exhaust valve(s) closed during a working cycle. According to the embodiments described herein, the deactivation mechanism may use a spring-loaded locking pin, which is moved by the application of pressurized hydraulic fluid, such as pressurized oil. If no oil pressure is applied, the locking pin spring forces the locking pin into an engaged position. In the engaged position, the deactivation mechanism is rigid and transmits a cam lobe profile into valve lift. When the oil pressure is applied, the oil pressure moves the locking pin against the spring pressure into a disengaged position. In the disengaged position, the deactivation mechanism is no longer rigid, and the cam lobe profile is not transmitted into valve lift.

FIGS. 5A-5D are fluid control schematic valve diagrams for each possible valve position of the oil control valves 410, 420 of the embodiment shown in FIG. 4. FIGS. 5A-D schematically illustrate four sets of oil flow paths in an oil control valve spool 412. Depending on the position of the spool 412 relative to the valve housing 414, one of these oil flow path sets will align with the four oil control valve ports 430, 440, 450, and 460 in the housing body 414.

As shown in FIG. 5A, the valve spool 412 is in a first or home position, which results in ports 450 and 460 being connected to port 440, the oil vent or return line. This position removes pressurized oil to both ports 450 and 460 activating both cylinders associated with this oil control valve. If both oil control 410 and 420 shown in FIG. 4 were in this position, all four engine cylinders would be activated. This position corresponds to no power applied to the solenoid, so it may be considered a fail-safe position having all cylinders activated.

As shown in FIG. 5B, the valve spool 412 is in a second position, which results in port 450 being connected to port 430 and port 460 being connected to port 440. This position applies pressurized oil to port 450 deactivating a cylinder associated with this port (cylinders 1 and 3 in FIG. 4). Also in this position, port 460 is vented to port 440 removing any oil pressure to a cylinder associated with this port (cylinders 2 and 4 in FIG. 4).

As shown in FIG. 5C, the valve spool 412 is in a third position, which results in ports 450 and 460 being connected to port 430, the pressurized oil line. This position applies pressurized oil to both ports 450 and 460 deactivating both cylinders associated with this oil control valve. If both oil control valves 410 and 420 shown in FIG. 4 were in this position, the two cylinders controlled by each of the two oil control would be deactivated, so all four engine cylinders would be deactivated.

As shown in FIG. 5D, the valve spool 412 is in a fourth position, which results in port 450 being connected to port 440 and port 460 being connected to port 430. This position applies pressurized oil to port 460 deactivating a cylinder associated with this port (cylinders 2 and 4 in FIG. 4). Also in this position, port 450 is vented to port 440 removing any oil pressure to a cylinder associated with this port (cylinders 1 and 3 in FIG. 4).

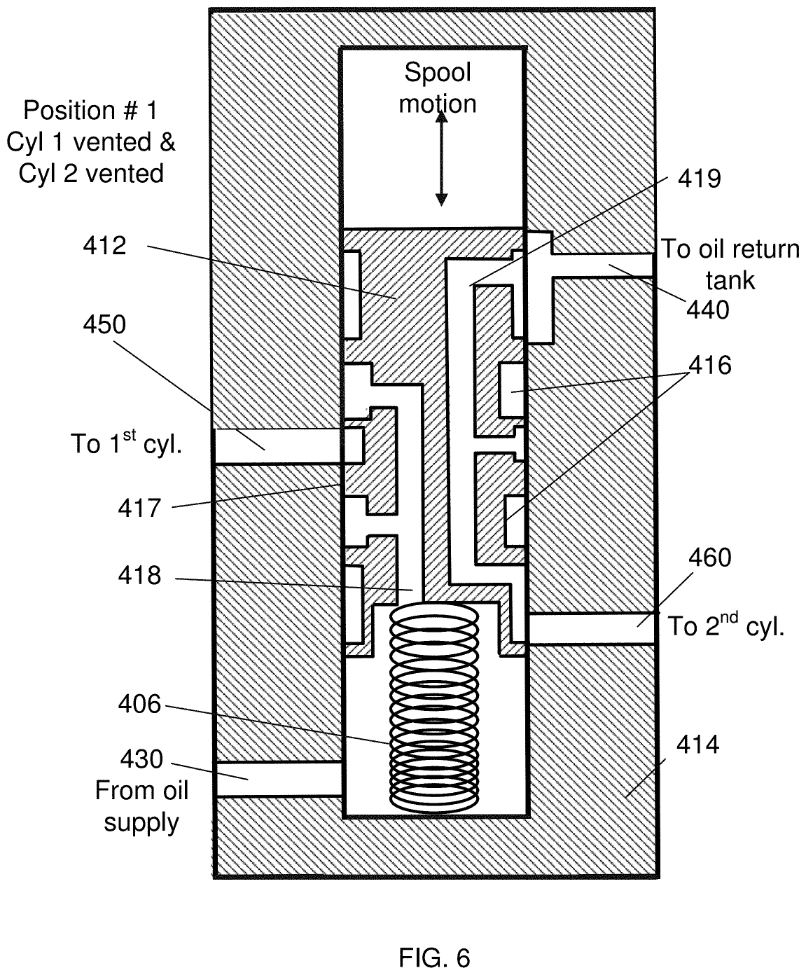

FIG. 6 shows a cross-sectional view of an exemplary 4-port, 4-position valve that has the functionality described relative to FIGS. 5A-5D. The 4-position valve has a spool 412 and valve housing 414. The valve housing 414 may have four ports 430, 440, 450, and 460, which make a fluid connection to an oil supply, an oil return tank, a first cylinder deactivation mechanism, and a second cylinder deactivation mechanism, respectively. The spool 412 may have a cylindrical shape. The spool may have a series of annular groves 416 formed at various locations along the outer perimeter of the spool 412. Separating the grooves 416 are lands 417 that form a seal between the barrel of the valve housing 414 and the spool 412 when the land 417 is aligned with a port. When one of the annular grooves 416 aligns with a port on the valve housing 414 fluid may flow between the annular groove 416 and port. These grooves may be fluidly connected to channels 418 and 419 oriented along the spool length. One channel 418 may be configured to deliver pressurized oil to cylinders and one channel 419 may be configured to vent oil away from the cylinders to the oil return tank. The position shown in FIG. 6 is the same position as shown in FIG. 5A, which results in ports 450 and 460 being connected to port 440, the vent line 440, which returns oil to the oil tank. This is the home, fail-safe position with the return spring fully extended and no power applied to the valve solenoid.

The spool 412 may move to various positions, i.e. home, mid-stroke, full stroke, within the housing barrel in response to applying electrical power to a solenoid (not shown in FIG. 6). The various spool positions correspond to various fluid connections between the ports. When no power is applied, the spool is in its home position, shown in FIG. 6 and schematically in FIG. 5A, forced there by a force exerted by the return spring 406. As more electrical power is applied to the solenoid, the spool 412 travels farther from its home position reaching its two mid-stroke (FIGS. 5B and 5C) and finally its full stroke position (FIG. 5D). To more efficiently deliver the electrical power to the solenoid, a pulse width modulation (PWM) circuit may be used to apply the electrical power. Greater motion for the spool 412 from its home position may be achieved by increasing the duty cycle of the PWM signal. A feedback mechanism may be used to assure that the spool 412 is correctly positioned at any of the mid-stroke locations so that an annular groove 416 is correctly aligned with an appropriate port. The spool motion through the mid-stroke positions may be sufficiently fast that no switching of a cylinder deactivation mechanism occurs during a switching transient.

It should be appreciated that the valve type and spool design depicted in FIG. 6 is exemplary only. Other valve types or configurations may be used, so long as they have the required functionality to control multiple cylinders from a single valve such that the controlled cylinders may have different firing patterns. For example, the order of the fluid connections on the spool 412 may be different that that depicted in FIG. 6. To speed spool motion, a second solenoid may replace the return spring 406. A rotary spool valve may be used instead of a sliding spool valve.

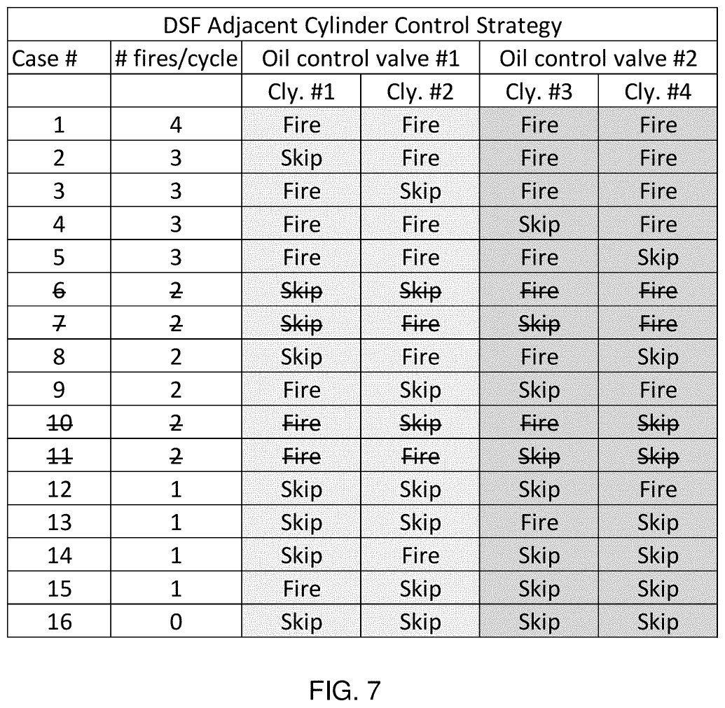

FIG. 7 shows the full matrix of control states for the two control valves 410, 420. As described above, control valve 410 controls Cylinder #1 480 and Cylinder #2 482. Control valve 320 controls Cylinder #3 484 and Cylinder #4 486. There are 16 possible skip/fire patterns for a four-cylinder engine. Some of the possible skip/fire patterns shown in FIG. 6 have text with a strikethrough. These are patterns that are possible, but would generally not be used since they would not be distributing working cycle skips and fires in as even a manner as possible and thus would produce more noise and vibration than other patterns having the same firing density with a more equal skip/fire distribution. Of these 16 patterns, one pattern results in four consecutive fires and one pattern results in four consecutive skips. There are four patterns that result in one skip and three fires and similarly four patterns that result in one fire and three skips. While there are six possible patterns that result in two skips and two fires, only two of these patterns would generally be used. The four patterns that would not generally be used are denoted by text with a strikethrough.

To generate these various patterns the oil control valves 410 and 420 are placed into one of their four positions. They can be independently place into any desired position. For example, when control valve 410 is controlling Cylinder #1 480 and Cylinder #2 482 to have control states of “fire” and “fire,” respectively, then no pressure is being applied to either control port A 450 or control port B 460. If control valve 410 is controlling Cylinder #1 480 and Cylinder #2 482 to have control states of “fire” and “skip,” respectively, then no pressure is being applied to control port A 450, but pressure is applied to control port B 460. Conversely, if control valve 410 is controlling Cylinder #1 480 and Cylinder #2 482 to have control states of “skip” and “fire,” respectively, then pressure is being applied to control port A 450, but no pressure is applied to control port B 460. If control valve 410 is controlling Cylinder #1 480 and Cylinder #2 482 to have control states of “skip” and “skip,” respectively, then no oil pressure is applied to either control port A 450 and control port B 460.

FIG. 7 illustrates a sequence of intake and exhaust valve motion in a four-cylinder engine.

The invention has been described primarily in the context of operating a naturally aspirated, 4-stroke, internal combustion piston engines suitable for use in motor vehicles. However, it should be appreciated that the described applications are very well suited for use in a wide variety of internal combustion engines. These include engines for virtually any type of vehicle—including cars, trucks, boats, aircraft, motorcycles, scooters, etc.; and virtually any other application that involves the firing of working chambers and utilizes an internal combustion engine. The various described approaches work with engines that operate under a wide variety of different thermodynamic cycles—including virtually any type of two stroke piston engines, diesel engines, Otto cycle engines, Dual cycle engines, Miller cycle engines, Atkinson cycle engines, Wankel engines and other types of rotary engines, mixed cycle engines (such as dual Otto and diesel engines), hybrid engines, radial engines, etc. It is also believed that the described approaches will work well with newly developed internal combustion engines regardless of whether they operate utilizing currently known, or later developed thermodynamic cycles. Boosted engines, such as those using a supercharger or turbocharger may also be used.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. For example, a four-position oil control valve that controls activation/deactivation of two cylinders is described. This oil control valve has four possible position. In some embodiments, an oil control valve having eight positions may be used. This oil control valve may control three cylinders such that they can operate with any desired firing pattern. It will be apparent to one of ordinary skill in the art that many modifications and variations are possible in view of the above teachings.

The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

While the embodiments have been described in terms of particular embodiments, there are alterations, permutations, and equivalents, which fall within the scope of these general concepts. It should also be noted that there are alternative ways of implementing the methods and apparatuses of the present embodiments. It is therefore intended that the following appended claims be interpreted as including all such alterations, permutations, and equivalents as fall within the true spirit and scope of the described embodiments.

What is claimed is:

1. A control valve in a valve train system of an internal combustion engine having a plurality of cylinders, the control valve configured for controlling a first cylinder and a second cylinder, the control valve comprising four ports comprising a pressure inlet port, a return port, a first control port for deactivating or reactivating elements of the first cylinder, and a second control port for deactivating or reactivating elements of the second cylinder.

2. The control valve as recited in claim 1, wherein the internal combustion engine is selected from a group consisting of a four cylinder engine, a six cylinder engine, and an eight cylinder engine.

3. The control valve as recited in claim 1, wherein the first cylinder and second cylinder are adjacent cylinders.

4. The control valve as recited in claim 1, wherein the control valve has four positions.

5. The control valve as recited in claim 4, wherein the control valve position is controlled by applying electrical power to a solenoid.

6. The control valve as recited in claim 1, wherein inlet pressure port is an oil supply port capable of supplying hydraulic pressure to the first control port and the second control port.

7. The control valve as recited in claim 1, wherein the control valve is capable of supplying hydraulic pressure to both first control port and the second control port.

8. The control valve as recited in claim 1 wherein the control valve is capable of supplying hydraulic pressure to either the first control port or the second control port, but not to both the first control port and the second control port.

9. The control valve as recited in claim 1, wherein the control valve is capable of blocking hydraulic pressure to both the first control port and the second control port, and wherein the control valve vents from both the first control port and the second control port to the tank port.

10. A valve train system of an internal combustion engine having a plurality of cylinders, comprising:
a plurality of deactivatable elements in each of the plurality of cylinders; and
at least one control valve configured for controlling a pair of cylinders, wherein the control valve comprises four ports.

11. The valve train system as recited in claim 10, wherein:
the plurality of cylinders comprises a first cylinder and a second cylinder and are adjacent one another; and
the four ports comprise a pressure inlet port, a return port, a first control port for deactivating or reactivating deactivatable elements of the first cylinder, and a second control port for deactivating or reactivating deactivatable elements of the second cylinder.

12. The valve train system as recited in claim 10, wherein the deactivatable elements comprise at least one of a hydraulic lash adjuster, a rocker arm, a lifter, and a zero lift cam.

13. The valve train system as recited in claim 10, further comprising an electromagnetic solenoid.

14. The valve train system as recited in claim 11, wherein the pressure inlet port supplies oil for hydraulically activating or deactivating the deactivatable elements.

15. The valve train system as recited in claim 10, wherein internal combustion engine is a four cylinder engine and the plurality of cylinders comprises two control valves.

16. The valve train system as recited in claim 10, wherein internal combustion engine is an eight cylinder engine and the plurality of cylinders comprises four control valves.

17. The valve train system as recited in claim 10, wherein internal combustion engine is an inline six cylinder engine and the plurality of cylinders comprises three control valves.

18. A control valve in a valve train system of an internal combustion engine having a plurality of cylinders, the control valve configured for controlling a first cylinder and a second cylinder, the control valve using four-way control logic, wherein the control valve can control the first and second cylinders with a control state selected from the group consisting of:
intaking hydraulic pressure and supplying the hydraulic pressure to both the first cylinder and the second cylinder;
intaking the hydraulic pressure and supplying the hydraulic pressure to the first cylinder while venting from the second cylinder to a tank;
intaking the hydraulic pressure and supplying the hydraulic pressure to the second cylinder while venting from the first cylinder to the tank; and
blocking intake of the hydraulic pressure and venting from both the first cylinder and the second cylinder to the tank.

19. The control valve as recited in claim 18, wherein the control valve comprise four ports including a pressure inlet port, a return port, a first control port for deactivating or reactivating elements of the first cylinder, and a second control port for deactivating or reactivating elements of the second cylinder.

20. The control valve as recited in claim 18, wherein the control valve is actuated by an electromagnetic solenoid with a return spring.
